(19) United States
(12) Patent Application Publication
(10) Pub. No.: US 2025/0233222 A1
(43) Pub. Date: Jul. 17, 2025

(54) METHOD FOR RECOVERING SOLID STATE ELECTROLYTE FROM ALL-SOLID-STATE-BATTERY

(71) Applicant: Korea Institute Of Geoscience And Mineral Resources, Daejeon (KR)

(72) Inventors: Soo-Kyung KIM, Sejong-si (KR); Moo-Ki BAE, Sejong-si (KR); Hyun-Ju LEE, Daejeon (KR); Hyun-Joon LEE, Daejeon (KR)

(73) Assignee: Korea Institute Of Geoscience And Mineral Resources, Daejeon (KR)

(21) Appl. No.: 19/016,694

(22) Filed: Jan. 10, 2025

(30) Foreign Application Priority Data
Jan. 15, 2024 (KR) 10-2024-0005990

(51) Int. Cl. H01M 10/54; C01B 25/30; C01F 17/229; C01G 25/02; C22B 1/24; C22B 7/00; H01M 10/0525

(52) U.S. Cl. CPC H01M 10/54; C01B 25/30; C01F 17/229; C01G 25/02; C22B 1/24; C22B 7/007; H01M 10/0525; H01M 2300/0077

(57) ABSTRACT

The purpose of the present disclosure is to provide a method for recovering a solid state electrolyte from an all-solid-state battery, which simultaneously recovers rare metals through a hydrometallurgical process. In order to achieve the purpose, an aspect of the present disclosure provides a method for recovering a solid state electrolyte from an all-solid-state battery, the method comprising steps of: (a) crushing or grinding the all-solid-state battery; (b) acid leaching the crushed or ground all-solid-state battery to form a leaching solution; (c) adding a first precipitant to the leaching solution to separate the leaching solution into a first precipitate and a first leachate; (d) adding a pH modifier to the first leachate to separate the first leachate into a second precipitate and a second leachate; and (e) adding a second precipitant to the second leachate to recover a third precipitate.

### CROSS-REFERENCE TO RELATED APPLICATION

This application claims priority to Korean Patent Application No. 10-2024-0005990 filed on Jan. 15, 2024, and all the benefits accruing therefrom under 35 U.S.C. § 119, the contents of which is incorporated by reference in its entirety.

### BACKGROUND OF THE DISCLOSURE

### 1. Field of the Disclosure

The present disclosure relates to a method for a method for recovering a solid state electrolyte from an all-solid-state battery. In particular, the present disclosure relates to a method for recovering a solid state electrolyte from an all-solid-state battery, which selectively recovers rare metals through a hydrometallurgical process.

### 2. Description of the Related Art

As the global electric vehicle market continues to grow, the size of the end-of-life electric vehicle market is expected to expand, which in turn is predicted to rapidly increase the size of the waste battery market.

Meanwhile, lithium-ion batteries use flammable organic liquid electrolytes, posing a constant risk of explosion.

The causes of explosions in lithium-ion batteries have been reported as gas generation due to overheating of the internal temperature, which results from the use of flammable organic liquid electrolytes, and electrical shorts caused by issues with the separator material.

Consequently, there is a growing demand for next-generation secondary batteries that are free from the risk of explosions and fires associated with lithium-ion batteries.

An all-solid-state battery is a secondary battery in which the liquid electrolyte and separator are replaced with a solid state electrolyte.

Because the all-solid-state batteries use a solid state electrolyte that combines the functions of a liquid electrolyte and a separator, phase change from solid to gas is nearly impossible, which reduces the risk of explosion. Additionally, the removal of the separator eliminates the fundamental cause of explosions. As a result, the all-solid-state battery market is expected to grow rapidly.

Solid state electrolytes can largely be classified into sulfide-based and oxide-based types. Oxide-based solid electrolytes can further be categorized into oxides, oxynitrides, and phosphates. Solid state electrolytes of each composition form crystalline phases with different structures and exhibit varying ionic conductivities.

In the conventional art, a method has been reported for recovering lithium by washing the cathode, anode, and electrolyte of an all-solid-state battery using a sulfide-based sintered body produced by heat-treating raw materials of lithium sulfide and phosphorus sulfide as a solid state electrolyte, and by dissolving lithium in water.

Furthermore, researches have been reported on recycling the LLZO (La₃Li₇O₁₂Zr₂) solid state electrolyte, where all components are classified as rare metals, using a hydrometallurgical process.

However, in the hydrometallurgical process for the aforementioned LLZO solid electrolyte, it is practically difficult to adjust the pH to a decimal precision, and there is an inconsistency between the pH conditions for precipitating zirconium oxide and the thermodynamic E-pH diagram.

Therefore, through extensive efforts and research, the applicant of the present disclosure has devised a method for recovering a solid state electrolyte from an all-solid-state battery, which selectively recovers the metals such as lanthanum (La), zirconium (Zr), and lithium (Li) using a hydrometallurgical process.

### SUMMARY OF THE DISCLOSURE

The purpose of the present disclosure, which aims to solve the aforementioned conventional problems, is to provide a method for recovering a solid state electrolyte from an all-solid-state battery, which selectively recovers rare metals through a hydrometallurgical process.

The problems to be solved by the present disclosure are not limited to those mentioned above, and other issues not explicitly stated will be clearly understood by those skilled in the art from the following description.

In order to achieve the purpose, an aspect of the present disclosure provides a method for recovering a solid state electrolyte from an all-solid-state battery, the method comprising steps of: (a) crushing or grinding the all-solid-state battery; (b) acid leaching the crushed or ground all-solid-state battery to form a leaching solution; (c) adding a first precipitant to the leaching solution to separate the leaching solution into a first precipitate and a first leachate; (d) adding a pH modifier to the first leachate to separate the first leachate into a second precipitate and a second leachate; and (e) adding a second precipitant to the second leachate to recover a third precipitate.

In some exemplary embodiments, the all-solid-state battery may be a lithium metal all-solid-state battery.

In some exemplary embodiments, the solid state electrolyte recovered from the all-solid-state battery may be a lithium lanthanum zirconium oxide (La₃Li₇O₁₂Zr₂).

In some exemplary embodiments, in the step (b), either one of an aqua regia or a sulfuric acid solution may be used in the acid leaching.

In some exemplary embodiments, in the step (c), the first precipitant may be an oxalic acid (C₂H₂O₄).

In some exemplary embodiments, in the step (c), the first precipitate may be a lanthanum oxalate (La₂(C₂O₄)₃·nH₂O).

In some exemplary embodiments, the step (c) may further comprise a step of calcining the first precipitate to recover a lanthanum oxide (La₂O₃).

In some exemplary embodiments, in the step (d), the pH modifier may be either one of a sodium hydroxide (NaOH) solution or a potassium hydroxide (KOH) solution.

In some exemplary embodiments, in the step (d), the second precipitate may be a zirconium dioxide (ZrO₂).

In some exemplary embodiments, in the step (e), the second precipitant may be a sodium phosphate (Na₃PO₄) solution.

In some exemplary embodiments, in the step (e), the third precipitate may be a lithium phosphate (Li₃PO₄).

In some exemplary embodiments, a recovery rate of the lanthanum oxide (La₂O₃) may be 99% or more.

In some exemplary embodiments, the second precipitate may be a zirconium dioxide (ZrO₂), and a recovery rate of the zirconium dioxide (ZrO₂) may be 98% or more.

In some exemplary embodiments, the third precipitate may be a lithium phosphate (Li₃PO₄), and a recovery rate of the lithium phosphate (Li₃PO₄) may be 89% or more.

According to an exemplary embodiment of the present disclosure, there is provided a method for recovering a solid state electrolyte from an all-solid-state battery, which selectively recovers rare metals through a hydrometallurgical process to enhance the recovery rate.

In addition, according to an exemplary embodiment of the present disclosure, there is provided a method for recovering a solid state electrolyte from an all-solid-state battery, which selectively recovers only the lanthanum (La) metal using oxalic acid (C₂H₂O₄).

In addition, according to an exemplary embodiment of the present disclosure, there is provided a method for recovering a solid state electrolyte from an all-solid-state battery, which enhances the leaching reaction rate of lanthanum (La) using the oxalic acid.

In addition, according to an exemplary embodiment of the present disclosure, there is provided a method for recovering a solid state electrolyte from an all-solid-state battery, which selectively recovers only the zirconium (Zr) metal using a sodium hydroxide (NaOH) solution.

In addition, according to an exemplary embodiment of the present disclosure, there is provided a method for recovering a solid state electrolyte from an all-solid-state battery, which selectively recovers only the lithium (Li) metal using a sodium phosphate (Na₃PO₄) solution.

The effects of the present disclosure are not limited to the aforementioned effects and should be understood to include all effects that can be inferred from the configurations of the present disclosure described in the detailed description or the claims.

### BRIEF DESCRIPTION OF THE DRAWINGS

FIG. 1 is a batch process diagram of a method for recovering a solid state electrolyte from an all-solid-state battery according to an exemplary embodiment of the present disclosure.

FIG. 2 is an X-ray diffraction diagram of the LLZO solid state electrolyte of a method for recovering a solid state electrolyte from an all-solid-state battery according to an exemplary embodiment of the present disclosure.

### DETAILED DESCRIPTION OF THE DISCLOSURE

The purpose of the present disclosure, which aims to solve the aforementioned conventional problems, is to provide a method for recovering a solid state electrolyte from an all-solid-state battery, which selectively recovers rare metals through a hydrometallurgical process.

Before describing the present disclosure in detail, the terms or words used in this specification should not be construed as being unconditionally limited to their ordinary or dictionary meanings, and in order for the inventor of the present disclosure to describe his/her disclosure in the best way, concepts of various terms may be appropriately defined and used, and furthermore, the terms or words should be construed as means and concepts which are consistent with a technical idea of the present disclosure.

That is, the terms used in this specification are only used to describe preferred embodiments of the present disclosure, and are not used for the purpose of specifically limiting the contents of the present disclosure, and it should be noted that the terms are defined by considering various possibilities of the present disclosure.

Further, in this specification, it should be understood that, unless the context clearly indicates otherwise, the expression in the singular may include a plurality of expressions, and similarly, even if it is expressed in plural, it should be understood that the meaning of the singular may be included.

In the case where it is stated throughout this specification that a component “includes” another component, it does not exclude any other component, but may further include any other component unless otherwise indicated.

Further, hereinafter, in describing the present disclosure, a detailed description of a configuration determined that may unnecessarily obscure the subject matter of the present disclosure, for example, a detailed description of a known technology including the prior art may be omitted. Hereinafter, exemplary embodiments of the present disclosure will be described in detail with reference to related drawings.

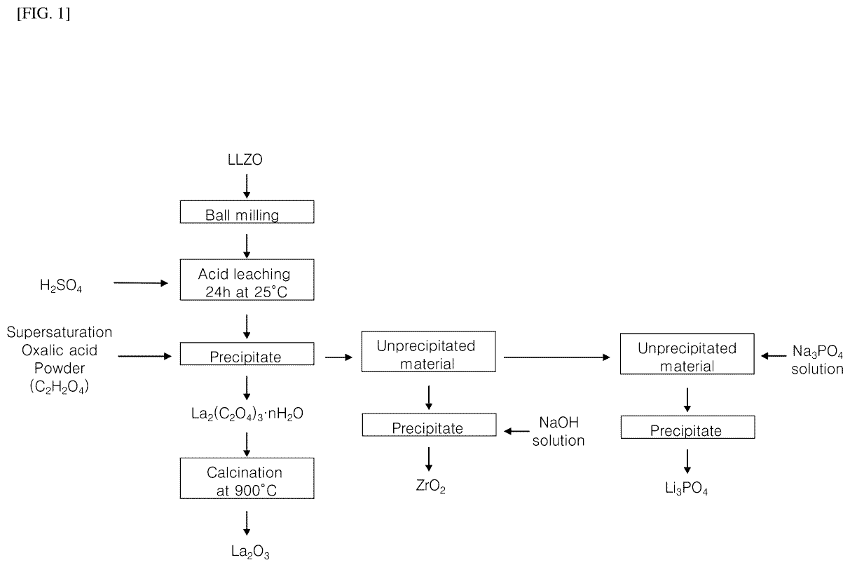

FIG. 1 is a batch process diagram of a method for recovering a solid state electrolyte from an all-solid-state battery according to an exemplary embodiment of the present disclosure.

As illustrated in FIG. 1, the method for recovering a solid state electrolyte from an all-solid-state battery may include steps of: (a) crushing or grinding the all-solid-state battery; (b) acid leaching the crushed or ground all-solid-state battery to form a leaching solution; (c) adding a first precipitant to the leaching solution to separate the leaching solution into a first precipitate and a first leachate; (d) adding a pH modifier to the first leachate to separate the first leachate into a second precipitate and a second leachate; and (e) adding a second precipitant to the second leachate to recover a third precipitate.

In particular, the method for recovering a solid state electrolyte from an all-solid-state battery may include steps of: (a) crushing or grinding the all-solid-state battery; (b) acid leaching the crushed or ground oxide-based all-solid-state battery to form a leaching solution; (c) adding an oxalic acid (C₂H₂O₄) to the leaching solution to separate the leaching solution into a lanthanum oxalate (La₂(C₂O₄)₃·nH₂O) and a first leachate; (d) adding a sodium hydroxide (NaOH) solution to the first leachate to separate the first leachate into a zirconium dioxide (ZrO₂) and a second leachate; and (e) adding a sodium phosphate (Na₃PO₄) solution to the second leachate to recover a lithium phosphate (Li₃PO₄).

The step (a) may be a step of crushing or grinding the all-solid-state battery.

The all-solid-state battery is a lithium metal all-solid-state battery.

The lithium metal all-solid-state battery may comprise a metal cathode, a lithium metal anode, and a solid electrolyte. In particular, the lithium metal all-solid-state may be a lithium symmetric cell.

Here, the lithium metal anode, made from metallic lithium, has the advantage of significantly increasing energy capacity and output compared to conventional graphite-based anodes. In contrast, the lithium metal anode has relatively lower stability and lifespan performance.

However, when this lithium metal anode is incorporated into an all-solid-state battery, it can yield the effect of innovatively enhancing energy capacity, output, lifespan, and stability.

The lithium metal all-solid-state battery may be crushed or ground using a dry crusher or grinder. Here, the type of dry crusher or grinder is not particularly limited and may follow known techniques and the general knowledge of a person skilled in the art. In some exemplary embodiments, the dry crusher or grinder may be a ball mill.

The lithium metal all-solid-state battery may be crushed or ground using a ball mill. In this case, when the lithium metal all-solid-state battery is crushed or ground with a ball mill, the particle size of the resulting powder decreases, improving the reduction and leaching efficiency of rare metals from the solid electrolyte during the acid leaching process.

The solid electrolyte of the all-solid-state battery may be a lithium lanthanum zirconium oxide (La₃Li₇O₁₂Zr₂). The LLZO (La₃Li₇O₁₂Zr₂) has a garnet-type crystalline structure and exhibits a very high ionic conductivity of approximately 104 S/cm at room temperature. Because the LLZO is chemically stable with respect to the metallic lithium, the LLZO can be used directly with a lithium metal anode to enhance the performance of the lithium metal all-solid-state batteries. Additionally, the LLZO is one of the most promising solid electrolytes in the field of all-solid-state battery technology. Therefore, the demand for LLZO-based all-solid-state batteries is expected to surge, making it essential to develop metal recovery technology for recycling LLZO.

The step (b) may be the step of acid leaching the crushed or ground all-solid-state battery to form a leaching solution.

In the step (b) above, the acid leaching process may use either one of an aqua regia or a sulfuric acid solution. Preferably, the sulfuric acid solution may be used.

Here, the rare metals may be recovered from the crushed all-solid-state battery powder through leaching in an inorganic acid solution.

When the aqua regia or the sulfuric acid solution is used in the acid leaching process, the spontaneous reactions may occur where Gibbs free energy calculated using Nernst's equation (ΔG=−nFE) for the chemical reactions that occur during the acid leaching process is less than zero. That is, lanthanum (La), zirconium (Zr), and lithium (Li) metal components may be dissolved from the LLZO, and the dissolved metals may be maintained in ionic form.

Here, when the sulfuric acid solution is used in the acid leaching process, the leaching time may be reduced, enabling the rapid recovery of rare metals from the LLZO.

In the step (b) above, the acid leaching process may be performed under conditions of a sulfuric acid solution of 2 M, a leaching temperature of 60° C., and a leaching time of 24 hours or less.

Here, under the conditions of the acid leaching process as above, the La, Zr, and Li metal components may be dissolved from the LLZO and maintained in ionic form.

The step (c) may be the step of adding a first precipitant to the leaching solution to separate the leaching solution into a first precipitate and a first leachate. Here, the first precipitate and the first leachate may be separated by filtration.

In the step (c), Lanthanum (La) metal may be recovered at first. Lanthanum (La) has a very low standard electromotive force, making it difficult to separate Lanthanum (La) by electroextraction. Therefore, Lanthanum (La) may be recovered simply and efficiently by selectively separating and purifying Lanthanum (La) through the separation and purification method using precipitation.

In the step (c) above, the first precipitant may be an oxalic acid (C₂H₂O₄).

The oxalic acid (C₂H₂O₄) may be in powder form.

The oxalic acid (C₂H₂O₄) powder may be added to the leaching solution until supersaturation is achieved, thereby separating the leaching solution into the first precipitate and the first leachate.

Here, when the oxalic acid powder is added until supersaturation, the driving force of the reactive crystallization mechanism increases, enhancing the reaction rate. This allows crystalline lanthanum oxalate hydrate to precipitate through nucleation and crystal growth, increasing the recovery rate of lanthanum oxide.

In the step (c), the first precipitate may be a lanthanum oxalate (La₂(C₂O₄)₃·nH₂O).

The lanthanum oxalate (La₂(C₂O₄)₃·nH₂O) may be a crystalline hydrate, a colorless substance with low solubility. The lanthanum oxalate can be decomposed through calcination.

The step (c) may further include a step of calcining the first precipitate to recover a lanthanum oxide (La₂O₃).

The first precipitate, lanthanum oxalate (La₂(C₂O₄)₃·nH₂O) may be calcined under the condition of temperature 900° C. to remove volatile components (H₂O, CO, CO₂) and to recover lanthanum oxide (La₂O₃), as shown in Reaction Formulas 1 to 3 below.

La(C₂O₄)₃·10H₂O→La(CO₂)₃+10H₂O [Reaction Formula 1]

3La₂(C₂O₄)₃→La₂O₂CO₃+3CO+2CO₂ [Reaction Formula 2]

La₂O₂CO₃→La₂O₃+CO₂ [Reaction Formula 3]

In the case where the temperature in the calcination process is below 900° C., the volatile components may not be removed, and thermodynamically stable lanthanum oxide may not be recovered. When the temperature exceeds 900° C., the manufacturing cost may increase without significantly affecting the recovery process of lanthanum oxide.

The step (d) may be the step of adding a pH modifier to the first leachate to separate the first leachate into a second precipitate and a second leachate. Here, the second precipitate and the second leachate may be separated by filtration.

In the step (d), zirconium (Zr) metal can be recovered. By modifying the pH of the first leachate based on the thermodynamic E-pH diagram, the zirconium (Zr) can be selectively separated and recovered easily and efficiently, without co-precipitating with other rare metal elements.

In the step (d), the pH modifier may be either one of a sodium hydroxide (NaOH) solution or a potassium hydroxide (KOH) solution. Preferably, the pH modifier may be a sodium hydroxide solution.

In the step (d), the second precipitate may be zirconium dioxide (ZrO₂).

When the pH of the first leachate is adjusted to 9 or higher using the pH adjuster, zirconium dioxide (ZrO₂) can be precipitated without co-precipitating other rare metal elements. As such, Zr can be selectively separated and recovered with simplicity and efficiency.

Here, the concentration of the sodium hydroxide solution added to the first leachate may be 10 M, and the added amount of the sodium hydroxide solution may be 50 mL (per 100 mL of the first leachate).

When the concentration or the added amount of sodium hydroxide solution is outside the above range, the pH of the first leachate may drop below 9, preventing the precipitation of zirconium dioxide (ZrO₂).

The step (e) may be the step of adding a second precipitant to the second leachate to recover a third precipitate. The third precipitate and the second leachate may be separated by filtration, allowing for the recovery of the third precipitate.

In the step (e), lithium (Li) metal can be recovered. By adding a precipitant, Li can be selectively separated and recovered easily and efficiently without co-precipitating with other rare metal elements.

In the step (e), the second precipitant may be a sodium phosphate (Na₃PO₄) solution.

In the step (e), the third precipitate may be a lithium phosphate (Li₃PO₄).

In the step (e), the lithium phosphate can be recovered through Reaction Formula 4 as below.

3Li₂SO₄+2Na₃PO₄→2Li₃PO₄+3Na₂SO₄ [Reaction Formula 4]

By adding the sodium phosphate solution to the second leachate, the lithium phosphate (Li₃PO₄) can be formed through a neutralization reaction.

Here, the concentration of the sodium phosphate solution added to the second leachate may be 1 M, and the added amount of the sodium phosphate may be 50 mL (per 100 mL of the second leachate).

When the concentration and the amount of the sodium phosphate solution are within the above range, the pH of the second leachate may increase, reducing the solubility of lithium phosphate, and thus enhancing the precipitation rate of the lithium phosphate.

Here, in the neutralization reaction, when the temperature is 60° C. or higher, the precipitation rate and the precipitation yield of lithium phosphate can be significantly improved.

Through the aforementioned method, the lanthanum oxide (La₂O₃) may be recovered.

Through the aforementioned method, the zirconium dioxide (ZrO₂) may be recovered.

Through the aforementioned method, the lithium phosphate (Li₃PO₄) may be recovered.

The recovery rate of the lanthanum oxide (La₂O₃) may be 99% or more.

The second precipitate may be a zirconium dioxide (ZrO₂), and the recovery rate of the zirconium dioxide (ZrO₂) may be 98% or more.

The third precipitate may be a lithium phosphate (Li₃PO₄), and the recovery rate of the lithium phosphate (Li₃PO₄) may be 89% or more.

Here, the recovered lanthanum oxide (La₂O₃), the recovered zirconium dioxide (ZrO₂), and the recovered lithium phosphate (Li₃PO₄) may be in powder form, and may have a purity of 99.9% or higher. If necessary, they can be dried in an oven before use. In addition, the recovered powders of lanthanum oxide (La₂O₃), zirconium dioxide (ZrO₂), and lithium phosphate (Li₃PO₄) may be recovered as La, Zr, and Li metals through heat treatment.

As described above, the method for recovering the solid state electrolyte from the all-solid-state battery according to an exemplary embodiment of the present disclosure has the effect of simultaneously recovering rare metals through a hydrometallurgical process and improving the recovery rate.

Furthermore, the method for recovering the solid state electrolyte from the all-solid-state battery according to an exemplary embodiment of the present disclosure achieves a recovery rate of around 90% for each of the aforementioned precipitates when the process is complete.

In addition, the method for recovering the solid state electrolyte from the all-solid-state battery according to an exemplary embodiment of the present disclosure enables the simple and efficient selective recovery of rare metals.

The effects of selectively recovering rare metals and improving the recovery rate from the solid state electrolyte of the all-solid-state battery using a hydrometallurgical process according to an exemplary embodiment of the present disclosure will be explained below with reference to the following experimental examples.

Through the following exemplary embodiments, lanthanum oxide (La₂O₃), zirconium dioxide (ZrO₂), and lithium phosphate (Li₃PO₄) were selectively recovered from the solid state electrolyte of the all-solid-state battery.

### Exemplary Embodiments

### <Exemplary Embodiment 1> Method for Recovering a Solid State Electrolyte from an all-Solid-State Battery

An all-solid-state battery consisting of a lithium metal cathode, a lithium metal anode, and an LLZO solid state electrolyte was prepared in the form of a lithium symmetric cell. The prepared lithium symmetric cell was crushed or ground using a ball mill to obtain an all-solid-state battery powder. The obtained all-solid-state battery powder was added to aqua regia to prepare a pulp with a concentration of 0.4%. The prepared pulp was stirred for 10 minutes. Acid leaching was then performed at a leaching temperature of 70° C. for 24 hours to produce a leaching solution.

### <Exemplary Embodiment 2> Method for Recovering a Solid State Electrolyte from an All-Solid-State Battery

There was prepared a simulated leaching solution that is similar to that in Exemplary Embodiment 1 above. La₂O₃, Li₂CO₃, and ZrO₂ chemical samples were added to a 2 M sulfuric acid solution to prepare a pulp. The prepared pulp was stirred for 10 minutes. Acid leaching was then performed at a leaching temperature of 60° C. for 24 hours to produce a simulated leaching solution.

### <Exemplary Embodiment 3> Method for Recovering a Solid State Electrolyte from an all-Solid-State Battery

An all-solid-state battery consisting of a lithium metal cathode, a lithium metal anode, and an LLZO solid state electrolyte was prepared in the form of a lithium symmetric cell. The prepared lithium symmetric cell was crushed or ground using a ball mill to obtain an all-solid-state battery powder. The obtained all-solid-state battery powder was added to aqua regia to prepare a pulp with a concentration of 0.4%, and the pulp was stirred for 10 minutes. Acid leaching was then performed at a leaching temperature of 25° C. for 24 hours to produce a leaching solution. Oxalic acid powder was added to the leaching solution until supersaturation to selectively precipitate lanthanum oxalate (La₂(C₂O₄)₃·nH₂O). The leachate was collected after the precipitation reaction.

### <Exemplary Embodiment 4> Method for Recovering a Solid State Electrolyte from an All-Solid-State Battery

An all-solid-state battery consisting of a lithium metal cathode, a lithium metal anode, and an LLZO solid state electrolyte was prepared in the form of a lithium symmetric cell. The prepared lithium symmetric cell was crushed or ground using a ball mill to obtain an all-solid-state battery powder. The obtained all-solid-state battery powder was added to aqua regia to prepare a pulp with a concentration of 0.4%, and the pulp was stirred for 10 minutes. Acid leaching was then performed at a leaching temperature of 25° C. for 24 hours to produce a leaching solution. Oxalic acid powder was added to the leaching solution until supersaturation to selectively precipitate lanthanum oxalate (La₂(C₂O₄)₃·nH₂O) as the first selective precipitation. After the precipitation reaction, the leachate was collected, and a sodium hydroxide (NaOH) solution was added to the leachate to selectively precipitate zirconium dioxide (ZrO₂) as the second selective precipitation. The leachate was collected after the precipitation reaction.

### <Exemplary Embodiment 5> Method for Recovering a Solid State Electrolyte from an all-Solid-State Battery

An all-solid-state battery consisting of a lithium metal cathode, a lithium metal anode, and an LLZO solid state electrolyte was prepared in the form of a lithium symmetric cell. The prepared lithium symmetric cell was crushed or ground using a ball mill to obtain an all-solid-state battery powder. The obtained all-solid-state battery powder was added to a 2 M sulfuric acid solution to prepare a pulp with a concentration of 0.4%, and the pulp was stirred for 10 minutes. Acid leaching was then performed at a leaching temperature of 60° C. to produce a leaching solution.

4.5 g of oxalic acid powder was added to 100 mL of the prepared leaching solution until supersaturation, to selectively precipitating lanthanum oxalate (La₂(C₂O₄)₃·nH₂O) for 1 hour. The recovered lanthanum oxalate (La₂(C₂O₄)₃·nH₂O) was then calcined at 900° C. to recover lanthanum oxide (La₂O₃). After the precipitation reaction, the leachate was collected. Then, 50 mL of 10 M NaOH solution was added to the collected leachate to selectively precipitate zirconium dioxide (ZrO₂) for 2 hours to recover as the second selective precipitation. The leachate was collected after the precipitation reaction, and 50 mL of 1 M Na₃PO₄ solution was added to selectively precipitate lithium phosphate (Li₃PO₄) to recover as the third selective precipitation.

### EXPERIMENTAL EXAMPLES

### <Experimental Example 1> Phase Analysis of LLZO Solid State Electrolyte

In the above-described exemplary embodiments, phase analysis of the LLZO solid state electrolyte in the all-solid-state battery was performed using an X-ray diffractometer.

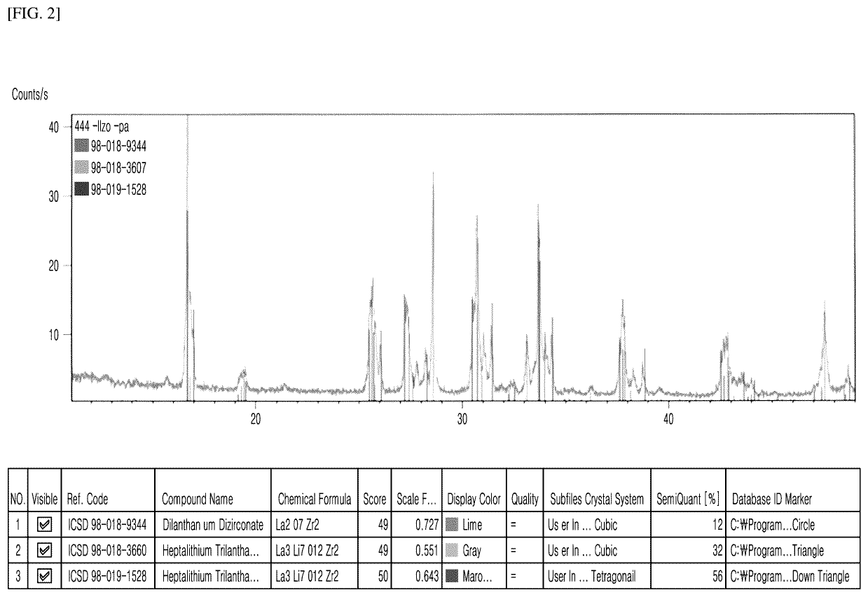

FIG. 2 is an X-ray diffraction diagram of the LLZO solid state electrolyte of a method for recovering a solid state electrolyte from an all-solid-state battery according to an exemplary embodiment of the present disclosure.

As shown in FIG. 2, the LLZO solid electrolyte of the initial all-solid-state battery was identified as having a La₃Li₇O₁₂Zr₂ crystalline phase.

### <Experimental Example 2> Analysis of Leaching Feasibility of LLZO Solid Electrolyte in Aqua Regia

In the above-described Exemplary Embodiment 1, the leaching solution obtained by acid leaching the crushed or ground all-solid-state battery powder in aqua regia was analyzed using an Inductively Coupled Plasma Optical Emission Spectrometer (ICP-OES). The analysis results are shown in [Table 1] below.

TABLE 1

| Element | Li | La | Zr | O |
|---|---|---|---|---|
| Amount (ppm) | 217 | 1661 | 789.5 | — |
| Theoretical | 57.86 | 496.24 | 217.27 | 228.63 |
| Amount (mg) | | | | |
| Actual Amount | 54.25 | 415.25 | 197.375 | — |
| (mg) | | | | |
| Error Rate (%) | 6.24 | 16.32 | 9.16 | — |
| Weight Ratio (%) | 5.78 | 49.62 | 21.72 | 22.86 |

Referring to [Table 1], it was confirmed that all rare metals (Li, La, Zr) were leached from the crushed or ground all-solid-state battery powder within the error range when leaching in aqua regia.

### <Experimental Example 3> Analysis of Leaching Feasibility of LLZO Solid Electrolyte in Sulfuric Acid Solution

In the above-described Exemplary Embodiment 2, the simulated leaching solution was analyzed using an Inductively Coupled Plasma Optical Emission Spectrometer (ICP-OES). The analysis results are shown in [Table 2] below.

TABLE 2

| Element | Li | La | Zr | O |
|---|---|---|---|---|
| Chemical Weight | 3.07 | 5.81 | 2.93 | — |
| (g) | | | | |
| Elemental Weight | 578.59 | 4962.41 | 2172.66 | — |
| (g) | | | | |
| Theoretical | 2892.96 | 24812.09 | 10863.32 | — |
| Concentration | | | | |
| (ppm) | | | | |
| Actual | 3679 | 18040 | 6253 | — |
| Concentration | | | | |
| (ppm) | | | | |
| Leaching Rate | 100 | 72.7 | 57.56 | — |
| (%) | | | | |

Referring to [Table 2] above, it was confirmed that all rare metals (Li, La, Zr) were leached in the simulated leaching solution using sulfuric acid. Although the leaching rate of metals other than Li was somewhat lower, the concentration of rare metals (Li, La, Zr) in the simulated leaching solution using sulfuric acid in Exemplary Embodiment 2 was higher in comparison to the leaching solution using aqua regia in Exemplary Embodiment 1. Therefore, it was ascertained that the leaching time for rare metals was reduced when using sulfuric acid solution.

### <Experimental Example 4> Analysis of Selective Leaching of La from LLZO Solid State Electrolyte in Aqua Regia

In the above-described Exemplary Embodiment 3, the leachate obtained was analyzed using an Inductively Coupled Plasma Optical Emission Spectrometer (ICP-OES). For reproducibility testing, Exemplary Embodiment 3 was performed twice and analyzed. The analysis results are shown in [Table 3] below.

TABLE 3

| | | | | |
|---|---|---|---|---|
| Element | Li | La | Zr | O |

| | | | | | |
|---|---|---|---|---|---|
| Test 1 | Initial | 108.5 | 880.5 | 394.8 | — |
| | State | | | | |
| | After | 141.7 | 61.74 | 586.5 | — |
| | Leaching | | | | |
| Test 2 | Initial | 51.2 | 436 | 197.4 | — |
| | State | | | | |
| | After | 64.86 | 24.04 | 279.7 | — |
| | Leaching | | | | |

Referring to [Table 3], no co-precipitation with other metals occurred during the La precipitation reaction. Therefore, La was selectively separated and purified, and it was confirmed that the precipitation rate of La was greater than or equal to 90%. The slight increase in the concentration of other metal elements is presumed to be due to the reduction in solution volume during filtration.

### <Experimental Example 5> Analysis of Selective Leaching of Zr from LLZO Solid State Electrolyte in Aqua Regia

In the above-described Exemplary Embodiment 4, the leachate that was obtained after the first and second precipitation reactions was analyzed using an Inductively Coupled Plasma Optical Emission Spectrometer (ICP-OES). The analysis results are shown in [Table 4] below.

TABLE 4

| Element | Li | La | Zr | O |
|---|---|---|---|---|
| Initial | 166.4 | 943.8 | 638.2 | — |
| Concentration | | | | |
| (ppm) | | | | |
| Concentration | 162.8 | 49.3 | 892.4 | — |
| after First | | | | |
| Precipitation | | | | |
| (ppm) | | | | |
| Concentration | 156.08 | 11.44 | 63.36 | — |
| after Second | | | | |
| Precipitation | | | | |
| (ppm) | | | | |
| Precipitation Rate | — | 95 | 90 | — |
| (%) | | | | |

Referring to [Table 4] above, it was confirmed that La and Zr were not affected by the first and second precipitation reactions, and their precipitation rates were greater than or equal to 90%. The concentration of La in the leaching solution using aqua regia was very low. Therefore, it was confirmed that the separation and purification experiments need to be performed again using an acid leaching solution with high concentrations of rare metals (Li, La, Zr).

### <Experimental Example 6> Analysis of Selective Leaching of Li, La, and Zr from LLZO Solid State Electrolyte in Sulfuric Acid Solution

In the above-described Exemplary Embodiment 5, the leachate obtained after the first, second, and third precipitation reactions was analyzed using an Inductively Coupled Plasma Optical Emission Spectrometer (ICP-OES). The analysis results are shown in [Table 5] below.

TABLE 5

| Element | Li | La | Zr | O |
|---|---|---|---|---|
| Initial | 2652 | 10330 | 3336 | — |
| Concentration | | | | |
| (ppm) | | | | |
| Concentration | 2424 | 5028 | 2883 | — |
| after First | | | | |
| Precipitation | | | | |
| (ppm) | | | | |
| Concentration | 1249 | 11.9 | 19.6 | — |
| after Second | | | | |
| Precipitation | | | | |
| (ppm) | | | | |
| Concentration | 270.6 | 17 | 38.2 | — |
| after Third | | | | |
| Precipitation | | | | |
| (ppm) | | | | |
| Precipitation Rate | 89.8 | 99.84 | 98.85 | — |
| (%) | | | | |

Referring to [Table 5] above, it was confirmed that La, Zr, and Li were not affected by the first, second, and third precipitation reactions, and their precipitation rates were around 90%. Therefore, it was demonstrated that rare metals (La, Zr, Li) could be selectively recovered from the solid state electrolyte of the all-solid-state battery using a hydrometallurgical process, and the recovery efficiency was improved.

In the above, although several preferred embodiments of the present disclosure have been described with some examples, the descriptions of various exemplary embodiments described in the “Detailed Description of the Disclosure” item are merely exemplary, and it will be appreciated by those skilled in the art that the present disclosure can be variously modified and carried out or equivalent executions to the present disclosure can be performed from the above description.

In addition, since the present disclosure can be implemented in various other forms, the present disclosure is not limited by the above description, and the above description is for the purpose of completing the disclosure of the present disclosure, and the above description is just provided to completely inform those skilled in the art of the scope of the present disclosure, and it should be known that the present disclosure is only defined by each of the claims.

According to an exemplary embodiment of the present disclosure, there is provided a method for recovering a solid state electrolyte from an all-solid-state battery, which selectively recovers rare metals through a hydrometallurgical process to enhance the recovery rate.

In addition, according to an exemplary embodiment of the present disclosure, there is provided a method for recovering a solid state electrolyte from an all-solid-state battery, which selectively recovers only the lanthanum (La) metal using oxalic acid (C₂H₂O₄).

In addition, according to an exemplary embodiment of the present disclosure, there is provided a method for recovering a solid state electrolyte from an all-solid-state battery, which enhances the leaching reaction rate of lanthanum (La) using the oxalic acid.

In addition, according to an exemplary embodiment of the present disclosure, there is provided a method for recovering a solid state electrolyte from an all-solid-state battery, which selectively recovers only the zirconium (Zr) metal using a sodium hydroxide (NaOH) solution.

In addition, according to an exemplary embodiment of the present disclosure, there is provided a method for recovering a solid state electrolyte from an all-solid-state battery, which selectively recovers only the lithium (Li) metal using a sodium phosphate (Na₅PO₄) solution.

What is claimed is:

1. A method for recovering a solid state electrolyte from an all-solid-state battery, the method comprising steps of:
(a) crushing or grinding the all-solid-state battery;
(b) acid leaching the crushed or ground all-solid-state battery to form a leaching solution;
(c) adding a first precipitant to the leaching solution to separate the leaching solution into a first precipitate and a first leachate;
(d) adding a pH modifier to the first leachate to separate the first leachate into a second precipitate and a second leachate; and
(e) adding a second precipitant to the second leachate to recover a third precipitate.

2. The method of claim 1,
wherein the all-solid-state battery is a lithium metal all-solid-state battery.

3. The method of claim 1,
wherein the solid state electrolyte recovered from the all-solid-state battery is a lithium lanthanum zirconium oxide (La₃Li₇O₁₂Zr₂).

4. The method of claim 1,
wherein in the step (b), either one of an aqua regia or a sulfuric acid solution is used in the acid leaching.

5. The method of claim 1,
wherein in the step (c), the first precipitant is an oxalic acid (C₂H₂O₄).

6. The method of claim 1,
wherein in the step (c), the first precipitate is a lanthanum oxalate (La₂(C₂O₄)₃·nH₂O).

7. The method of claim 1, wherein the step (c) further comprising a step of:
calcining the first precipitate to recover a lanthanum oxide (La₂O₃).

8. The method of claim 1,
wherein in the step (d), the pH modifier is either one of a sodium hydroxide (NaOH) solution or a potassium hydroxide (KOH) solution.

9. The method of claim 1,
wherein in the step (d), the second precipitate is a zirconium dioxide (ZrO₂).

10. The method of claim 1,
wherein in the step (e), the second precipitant is a sodium phosphate (Na₃PO₄) solution.

11. The method of claim 1,
wherein in the step (e), the third precipitate is a lithium phosphate (Li₃PO₄).

12. The method of claim 7,
wherein a recovery rate of the lanthanum oxide (La₂O₃) is 99% or more.

13. The method of claim 1,
wherein the second precipitate is a zirconium dioxide (ZrO₂), and
wherein a recovery rate of the zirconium dioxide (ZrO₂) is 98% or more.

14. The method of claim 1,
wherein the third precipitate is a lithium phosphate (Li₃PO₄), and
wherein a recovery rate of the lithium phosphate (Li₃PO₄) is 89% or more.
